(19) United States
(12) Patent Application Publication
(10) Pub. No.: US 2004/0021562 A1
(43) Pub. Date: Feb. 5, 2004

(54) Method for assigning tire modules to wheel positions of a tire pressure monitoring system for a vehicle and device for monitoring tire pressure

(76) Inventor: Martin Prenninger, Regensburg (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/444,282

(22) Filed: May 23, 2003

(30) Foreign Application Priority Data
May 24, 2002 (DE) 102 23 214.8

(51) Int. Cl. B60C 23/00

(52) U.S. Cl. 340/445

(57) ABSTRACT

Tire modules (3) are assigned to wheel positions when the wheel speed is above a threshold value. Each tire module (3) transmits a number of signals together with at least one tire-specific identifier over a predetermined period. An antenna (5) positioned asymmetrically in respect of the wheel positions receives the intensity patterns based on wheel rotation and compares these intensity patterns with reference models. In the case of at least broad correspondence with a specific reference model the respective intensity pattern and the associated identifier are assigned to a wheel position.

### PRIORITY

This application claims foreign priority of the German application DE 10223214.8 filed on May 24, 2002.

### TECHNICAL FIELD OF THE INVENTION

The invention relates to a method for assigning tire modules to wheel positions of a tire pressure monitoring system and a device for monitoring tire pressure.

### BACKGROUND OF THE INVENTION

The tire pressure of vehicle tires should be checked regularly for safety reasons, in particular during travel. For this purpose devices are located in each tire to detect the tire pressure. These have at least one pressure sensor, which measures tire pressure. The measured value is then transferred in a signal by means of a transmitter via an antenna to a vehicle-side receiver. The transfer may take place intermittently at predetermined intervals. The transfer may also be activated by receipt of a prompt signal, which is in turn transmitted by the vehicle-side transmitter. An energy source may be contained in each tire-side device (tire module). Energy may however also be transferred to the device along with the prompt signal and said energy is then used to send the pressure signal back to the vehicle.

An individual identifier, characteristic of the tire, is generally also transferred with the pressure signals. The identifier is stored in each instance in the electronic unit of each tire. The pressure signals received by the vehicle-side receivers are fed to a vehicle-side, central analysis unit, with which each signal is then analyzed and the measured pressure compared with permitted reference values. In the event of a deviation from the reference values, a display is activated, which shows the driver that appropriate measures (tire change or additional air) should be taken. For safety purposes a number of measurements may also be taken and a mean value or time-based value calculated from these, which is then compared with the reference value, which may also change over time.

In order that the analysis unit knows precisely the tire for which an air pressure has been reported, the analysis unit must be informed at least once during travel which sensor and therefore which identifier is assigned to which wheel position. Such assignment (also known as location) is known for example from patent specification EP 0 861 160 B1. Here a receiver is assigned to each wheel, by means of which the signals are received from the devices in the tires. As the receivers are positioned near to the tires, the intensities/amplitudes/field strengths of the received signals from the assigned tires are greatest, while the intensities from other wheels are much smaller. As a result the signals occurring most frequently or with the greatest strength can be assigned to the corresponding wheel and the associated wheel position. Assignment takes place during travel, in order to distinguish the operating wheels from the spare wheel.

With this known location method one receiver must be assigned to each wheel, which is very complex and expensive.

In a further known method for assigning wheel positions (EP 0 967 095 A2) assignment is initiated during travel. However the tires must be pumped up beforehand to different levels in a specific sequence, so that a distinction can be made between the wheels. For this the front, left wheel is pumped to the lowest pressure, etc. up to the rear, right wheel with the highest pressure. The front, left position is then assigned by the tire module receiving the lowest pressure. The procedure is the same for the other wheels.

The wheels only have to have different tire pressures for location purposes, so that assignment can be carried out. This is very expensive and time-consuming as all the tires or at least the front tires and each of the rear tires have to be pumped up to the same pressure afterwards.

### SUMMARY OF THE INVENTION

The invention has to overcome the problem of creating a method for assigning tire modules to wheel positions of a wheel monitoring system that is simple and reliable and does not incur additional expenditure. The invention also has to overcome the problem of creating a device for monitoring the tire pressure of tires, with which both the assignment of tire modules to wheel positions and the measurement of tire pressure can be carried out easily.

According to the invention these objects can be resolved by a method for assigning tire modules to wheel positions of a tire pressure monitoring system for a vehicle, with each tire module having at least one pressure sensor and one transmitter, which transmits a signal to a vehicle-side receiver with a connected analysis unit, in which the signals are analyzed, wherein

assignment is activated by a sensor, when the vehicle or wheel speed is above a reference value,

after this each tire module transmits a number of signals over a predetermined interval together with an identifier specific to a tire,

the signals, which produce a time-based intensity pattern due to wheel rotation, are received by a receiver, the respective intensities are detected and the identifier extracted, and wherein

the intensity patterns received by the receiver are compared with reference models, with a reference model being stored for each wheel position and in the event of at least broad correspondence, the identifiers assigned to the intensity patterns are assigned to the wheel positions.

The objects can furthermore be solved by a method for assigning tire modules to wheel positions of a tire pressure monitoring system for a vehicle, with each tire module having at least one pressure sensor and one transmitter, which transmits a signal to a vehicle-side receiver with a connected analysis unit, in which the signals are analyzed, the method comprising the steps of:

activating the assignment by a sensor, when the vehicle or wheel speed is above a reference value,

transmitting a number of signals over a predetermined interval together with an identifier specific to a tire by each tire module,

receiving the signals, which produce a time-based intensity pattern due to wheel rotation, by a receiver,

detecting the respective intensities and extracting the identifier, and

comparing the intensity patterns with reference models, with a reference model being stored for each wheel position and in the event of at least broad correspondence, assigning the identifiers assigned to the intensity patterns to the wheel positions.

The pressure values measured in the tires and/or a specific identifier for each tire can be contained in the signals. The vehicle or wheel speed can be measured in each wheel by a sensor. The speed data in any case available in the vehicle can be used as information about vehicle or wheel speed. A value characterizing wheel rotation and/or a temperature value measured in the tire can be contained in the signals. Statistical methods can be used to analyze the received signals.

The objects can furthermore be solved by a device for monitoring the tire pressure of tires on a vehicle, comprising a tire module with at least one pressure sensor and one transmitter with a transmitter antenna, at least one vehicle-side receiver, the receiver antenna of which is positioned asymmetrically in respect of the wheel positions, and a sensor, which measures wheel acceleration, wheel speed or vehicle speed and which triggers an activation signal for the transmission of signals from the tire-side transmitters to the vehicle-side receiver over a predetermined period, when a reference value has been exceeded.

The sensor can be an acceleration sensor and one acceleration sensor can be located in each tire module. The transmitter may be part of a transponder, which sends one or more signals back to the vehicle-side receiver after receiving a prompt signal, transmitted from a vehicle-side transmitter. The sensor may be a speed or acceleration sensor in any case in use in the vehicle, with the prompt signal being generated for each tire module, when the vehicle speed is above the reference value. A number of receiver antennas can be distributed in the vehicle and positioned asymmetrically in respect of the wheel positions and receive the signals from the tire modules, with all the receiver antennas being connected to a central analysis unit.

Assignment here is activated by an acceleration or speed sensor, when the vehicle or wheel speed is above a reference value. The tire modules then transmit a number of signals over a predetermined period, with at least one tire-specific identifier also being transferred in the signal. The received field strength is measured on a time basis for each signal (intensity pattern) and the associated identifier is extracted from the signal. The intensity patterns are then compared with reference models, with one reference model being stored beforehand for each wheel position in the existing configuration (spatial arrangement of the receiver antennas in the vehicle). In the event of at least broad correspondence with one of the reference models, the identifier assigned to the corresponding intensity pattern is then assigned to the wheel position assigned to the reference model.

As the wheels are rotating while the signals are being transmitted, different intensities are received at the receiver. If the receiver is arranged asymmetrically in respect of the wheel positions in the vehicle, it receives a specific intensity pattern characteristic of the wheel position from each tire module over the predetermined period, as the transfer paths between the transmitters in the tires and the receiver in the vehicle are of different lengths. The longer the transfer path, the more the intensity of the transferred signal is attenuated. Assignment can be carried out reliably by comparing or correlating with the reference models.

As only one receiver needs to be arranged asymmetrically in the vehicle, such a device can also be used to monitor tire pressure both during travel and when the vehicle is stationary. As assignment is carried out during travel, no adjacent vehicle should be likely to interfere with assignment, as might otherwise be the case when assignment takes place in a parked vehicle. Also a distinction can be made between one of the four or more operating wheels and the spare wheel, as the intensity pattern of the spare wheel is broadly constant over the period. This is due to the distance between the transmitter in the spare wheel and the receiver antenna, which remains the same even during travel.

The identifier at least is transmitted for the assignment of tire modules to wheel positions. The measured pressure values may also be transmitted. In the receiver on the one hand the amplitudes or field strengths (intensities) of the received signals are detected. However this requires all transmitters in the various tire modules to transmit at around the same strength or at a known strength. If the pressure values are transmitted with the identifier, the identifier/wheel position assignment can take place at the same time as a tire pressure measurement.

The vehicle or wheel speed can then be obtained in each wheel, for example by an acceleration sensor or by means of wheel or speed data otherwise available in the vehicle. If the speed is higher than a predetermined value, assignment is activated. Standard air pressure measurements are then taken at predetermined intervals during normal operation. If the speed is below a reference value, monitoring of tire pressure may be terminated, as there is no longer a safety-critical situation and tire pressure no longer has to be measured.

A value for a physical variable characterizing wheel rotation can also be included in the transferred signals. Tire temperature can also be measured and can be used on the one hand to correct the pressure value or on the other hand as additional information relating to the tire pressure.

Statistical methods such as correlation, mean value, standard deviation, etc. can be used to analyze the intensities. Simple and reliable methods can therefore be used to obtain unambiguous information about the wheel position associated with the respective identifier by means of comparison with the reference models. The device may be what is referred to as a unidirectional tire monitor, in which signals are only sent from the tires to the central receiver. It may also be what is known as a transponder unit (bi-directional transfer), in which a prompt signal is transmitted from a vehicle-side transmitter, upon which the tire modules, which receive the prompt signal, automatically send back a signal containing the identifier, the pressure value, the temperature value and/or the wheel acceleration value to the central receiver.

One or more receivers may be present in the vehicle. It is important that the receivers are positioned asymmetrically in respect of the wheel positions, so that the transfer paths of the individual signals from the wheels to the antenna of the receiver vary, so that the intensity patterns transmitted by a tire module and detected at the site of the antenna differ clearly during the period from the intensity patterns of other wheel modules.

### BRIEF DESCRIPTION OF THE DRAWINGS

Embodiments of the invention are described in more detail below using the drawings. These show:

FIG. 1 a diagrammatic view of a vehicle with a device according to the invention for monitoring the tire pressure of tires,

FIG. 2 a block circuit diagram of a tire pressure measurement device in the tire,

FIG. 3 a block circuit diagram of a receiver and analysis unit in the vehicle,

FIG. 4 a flow diagram of a method for assigning tire pressure measurement devices to tire positions and

FIGS. 5A-5H intensity patterns and frequency distributions of field strengths of the signals received from the tire pressure measurement devices in the tires.

### DETAILED DESCRIPTION OF THE PREFERRED EMBODIMENTS

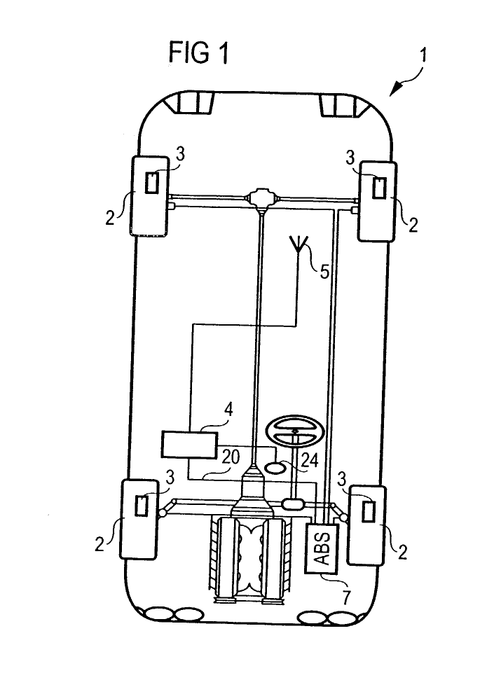

A device for measuring the tire pressure of each tire on a vehicle 1 (FIG. 1) has a tire pressure measuring device (also referred to as a tire module 3) in every tire 2 (including the spare wheel). These tire modules 1 measure a physical variable, which is a measure of the pressure in the tire 2. This may be the tire pressure and/or the temperature in the tire 2 directly. The measured physical variable is converted to an electrical signal and sent together with an identifier to a vehicle-side, central analysis unit 4.

For this the analysis unit 4 has at least one antenna 5 positioned asymmetrically in respect of the respective wheel positions VL, VR, HL, HR in the vehicle 1, which receives the signals received from the tire modules 3 and forwards them to the analysis unit 4. The receiver 6 required to demodulate the signals can be integrated in the analysis unit 4.

The central analysis unit 4 may be connected to a driver assistance system 7 present in the vehicle 1 in any case via a data bus 8. This means that the analysis unit 4 can access data which is in any case available in the vehicle 1.

Drive stability regulation systems or drive dynamic regulation systems, such as anti-locking brake systems (ABS), anti-skid regulators (ASR), an electronic stability program (ESP) or traction control may be used as driver assistance systems 7. These may also include engine control or transmission control. Sensors 8 are generally positioned near to the wheels for the driver assistance systems 7, to measure the speed of the wheels. These wheel speeds are required for the driver assistance systems 7 and are processed there. Fixed assignment (due to attachment in proximity to the wheel) of each speed sensor 8 to the respective wheel position means that the associated wheel position is also known to the driver assistance system 7, i.e. it is known which wheel is located where and how fast the respective wheel is rotating (wheel speed V_{Rad}). The wheel and vehicle speed V_{Rad/Kfz} is therefore in any case available in the vehicle 1 for the analysis unit 4.

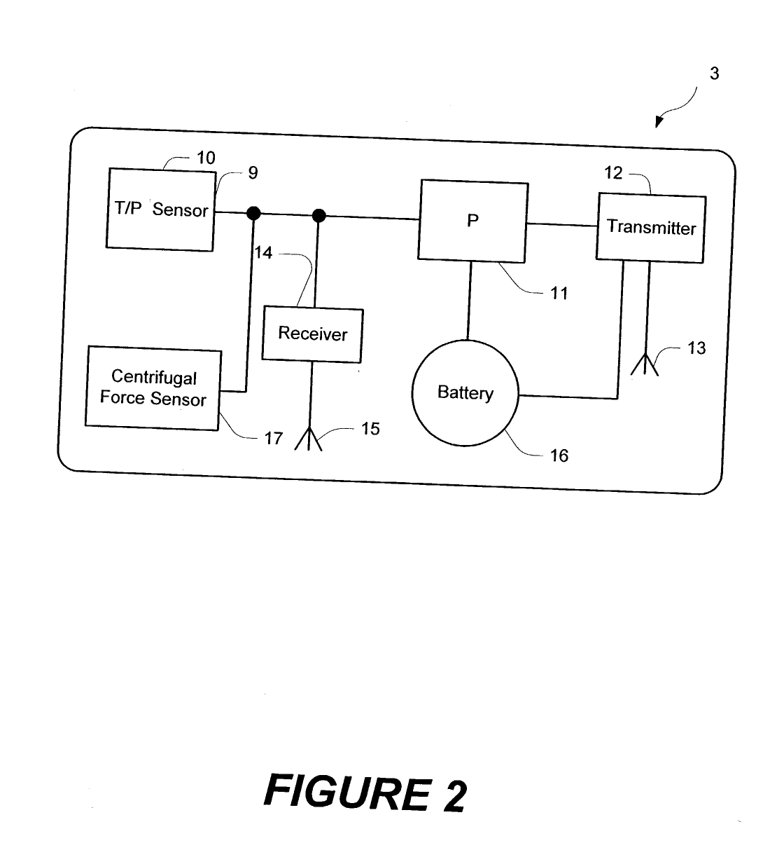

A tire module 3 is shown in FIG. 2 with an example of a possible structure. Such a tire module 3 may be positioned on the rim, on the tire bead, in the tire material or at any other appropriate point on the tire 2 of each wheel. This tire module 3 has at least one pressure sensor 9, which is used to measure the air pressure of the tire 2. It may also have a temperature sensor 10, which measures the temperature in the tire 2.

The measured values are fed to a control unit (in this case a microprocessor 11), which processes them and feeds them together with an identifier characterizing the tire 2 and where necessary further data to a transmitter 12 for transmission via a transmitter antenna 13. For identifier/wheel position assignment, the identifier at least is transmitted a number of times within a predetermined period after activation. Transmission may be repeated at predetermined intervals. Data may be transmitted using high-frequency carrier frequencies, for example at around 433 MHz or even 315 MHz, or at low frequency carrier frequencies, for example at around 125 kHz.

The tire module 3 may also have a receiver 14 with a receiver antenna 15 (this is then referred to as a transponder), by means of which signals can be received from an analysis unit 4 in the vehicle 1, in order for example to activate pressure measurement and assignment of identifiers to wheel positions.

The transmitter and receiver antennas 13, 15 may also be combined in a single antenna. The antennas 13, 15 may be positioned in the tire 2 in the form of coils or rod antennas (strip or wire antennas), i.e. in or inside on the tire material, on the rim or as part of the air valve.

All the components of the respective tire modules 3 are supplied with current and voltage by a battery 16. The battery 16 may not be required, if the tire module 3 takes its energy from the received signal (prompt signal), as is frequently the case with the transponder principle.

The tire module 3 may also have a kinematics sensor 17 (centrifugal force sensor, acceleration sensor), which measures a physical variable, which can only be measured in motion, i.e. during travel. This physical variable is a measure of the rotation or speed of the wheel. This means for example that the centrifugal force occurring during rotation of the wheel can be measured using the centrifugal force sensor as a kinematics sensor 17.

Alternatively the temperature sensor 10 could also supply a physical variable, the temperature, which is a measure of wheel speed. This is because the interior of the tire heats up due to the deformation of the tire 2. The faster and longer the travel, the higher the tire temperature.

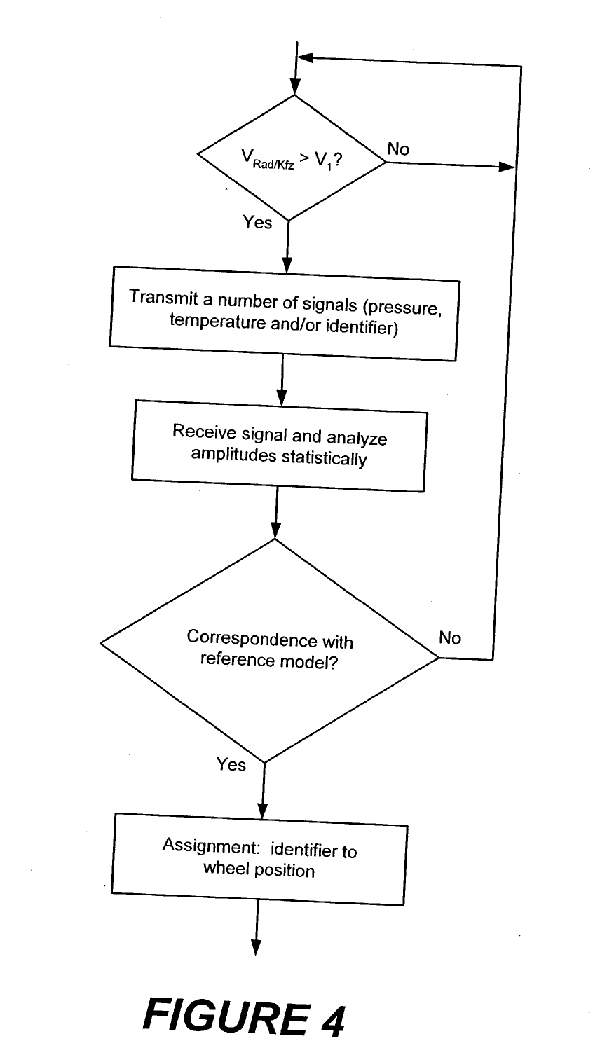

The values measured by the kinematics sensor 17 are fed to the microprocessor 11. If the wheel rotation is above a predetermined reference value or a limit value (corresponds to a threshold value for vehicle speed v₁), the microprocessor may be instructed to initiate assignment mode. As a result a signal is transmitted for a predetermined period, which contains at least a tire-specific identifier and where necessary values for pressure and/or temperature (see FIG. 4).

The speed threshold value v₁ (for example 30 km/h) is selected so that the identifier/wheel position assignment is definitely carried out during travel. The prespecified period is such that a number of signals are transmitted during one or more wheel rotations, which can then be analyzed at the receiver site in respect of their intensity pattern. An adequate number of measured values must be available to analyze the intensity pattern, so that the entire pattern can be analyzed statically regardless of any outliers.

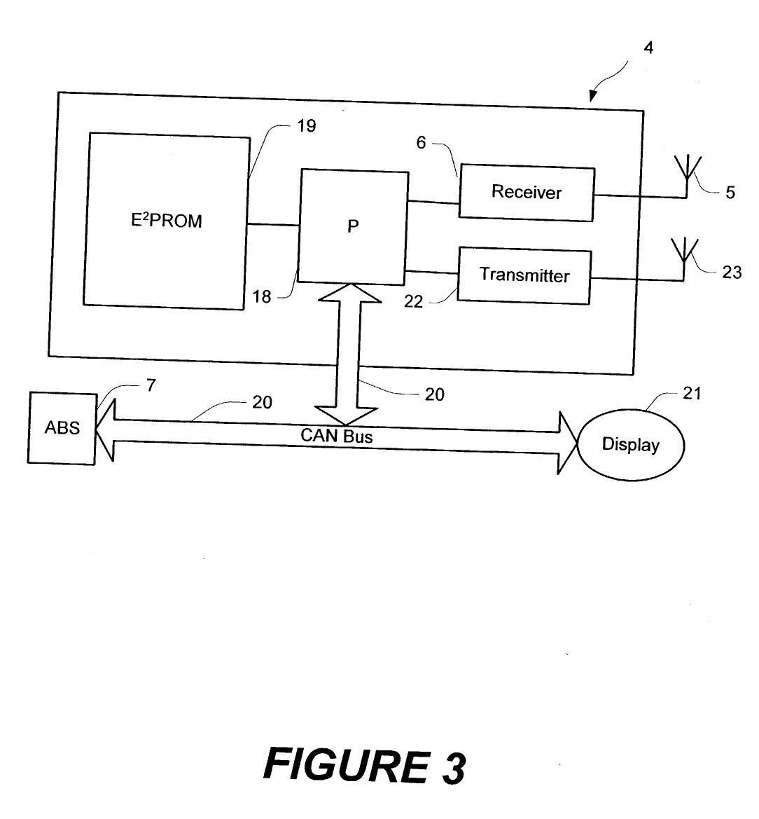

FIG. 3 shows the central receiver and analysis unit 4 in detail. The receiver and analysis unit 4 receives signals transmitted from each tire pressure measuring device via one or more receiver antennas 5. The receiver antenna 5 forwards every received signal via a receiver 6 to a microprocessor 18. The intensities or field strengths can already be measured in the receiver on a time basis (the amplitudes are measured on a time basis). The data demodulated from the signal (such as identifier) is fed to the microprocessor 18. In this way the distribution over time and associated identifier are ascertained for each intensity pattern.

The microprocessor 18 is connected to a data storage unit 19.

Reference models, target or reference values for tire pressure, reference temperature, assignment of identifiers to wheel position, etc. can be stored in this storage unit 19. The storage unit 19 may also be a dynamic storage unit, in which the stored values are adapted dynamically to new circumstances. In this way assignments of identifiers to wheel positions may be changed, if it should be identified on the basis of intensity distribution, by comparing the typical intensity distribution for each wheel, that new tires 2 have been fitted or the wheel positions of existing tires have been changed during a stop.

The analysis unit 4 may be connected via a data bus 20 of the vehicle 1, for example a CAN bus. The microprocessor 18 can obtain data from other units in the vehicle 1, for example the driver assistance system 7, via this bus 20. In this way the microprocessor 18 can obtain data about vehicle speed and then, if minimum speed is exceeded, it can send a prompt signal via a transmitter 22 to each tire module 3, to activate assignment of identifiers to wheel positions.

In assignment mode the analysis unit 4 compares the respective intensity patterns geometrically with the reference models stored for each tire 2. In the case of those intensity patterns which correspond at least broadly to one of the reference models, the identifier associated with the intensity pattern is assigned to the wheel position assigned to the respective reference model and stored at least on a temporary basis.

This means that identifier to wheel position assignments are known in the analysis unit 4. In normal operation (tire pressure measurement in the tires 2), it is subsequently known on receipt of the pressure values on the basis of the identifiers transmitted with the pressure values, which tire 2 (which wheel position) is the location of the respectively measured pressure value. As a result data or a warning can be sent to the driver via the bus 20, by displaying the data visually and/or acoustically on a display unit 21.

The display unit 21 is advantageously positioned within the field of vision of the driver, for example on the dashboard.

The analysis unit 4 may have a transmitter 22, which can be used to send signals via a transmitter antenna 23 to the individual tire modules 3 in the tires 2 (sending of prompt signal, if necessary together with energy for the tire module 3).

In normal operation the pressure values of the individual tires 2 are sent together with the identifier of the tires 2 to the analysis unit 4. This compares the values on the basis of the identifier with the minimum and/or maximum permitted pressure values (reference or target values) stored for the identifier and therefore for the wheel position.

These reference values were stored beforehand in the storage unit and can be adapted dynamically to the measured values, if for example the tire pressure increases solely due to an ambient temperature increase or an ambient pressure increase. This means that pressure losses, which might result in safety-critical situations as a result of a defective tire 2, are reliably identified.

If the pressure values measured are below or above the reference pressure values, a warning signal is transmitted, informing the driver of the wheel position VL, VR, HL, HR at which there is a tire 2 with too high or too low pressure.

So that each tire module is definitively assigned to a wheel position, assignment mode must first be initiated. This is started according to the invention, when the wheel or vehicle speed v_{Rad/Kfz} is higher than a predetermined minimum speed v₁ (for example 20 km/h). At least the identifier of each tire module 3 is then sent to the analysis unit 4. Pressure, temperature and/or wheel speed (if this is measured in the wheel) may also be sent with the identifier. Location (assignment) can then be carried out with those signals, in which the measured pressure values are also transferred.

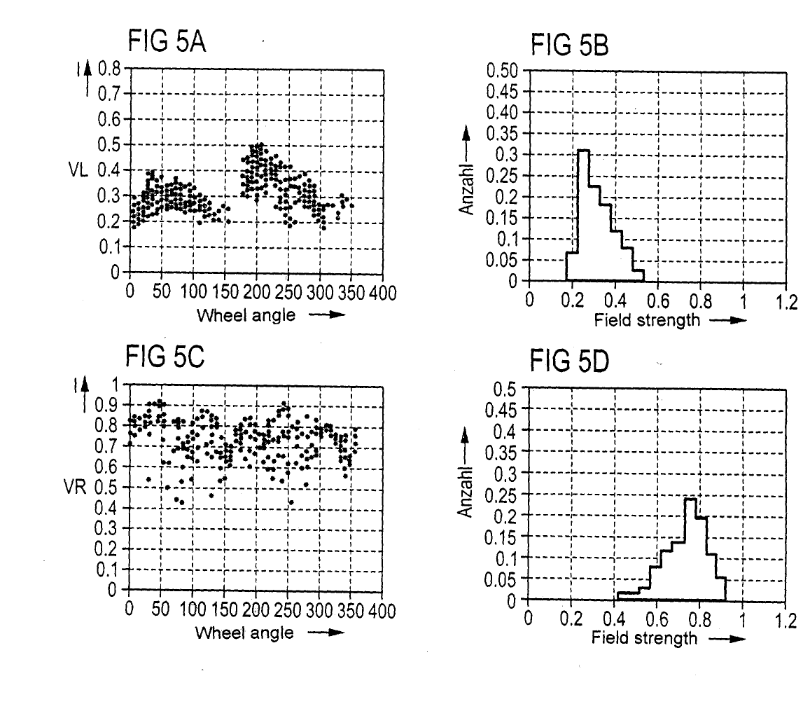

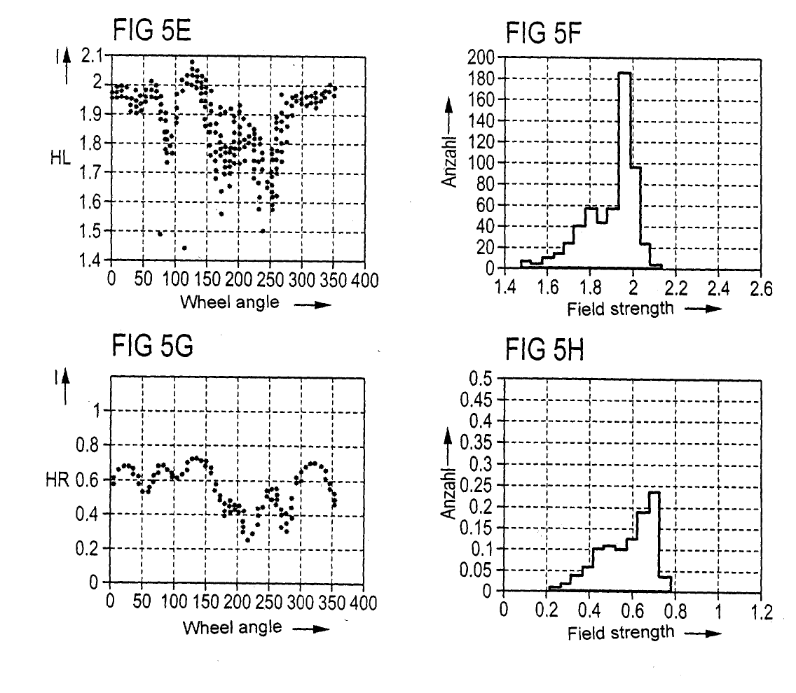

The signals are transmitted a number of times over a predetermined period. As the wheels are rotating during this process, changes to the received intensity based on the angle of rotation of the respective wheel necessarily occur at the receiver site, due to a change in the length of the transfer path and the associated change in signal attenuation. The intensity patterns of all operating wheels (excluding the spare wheel here) are shown in FIGS. 5A to 5H.

The time-based intensity values associated with each identifier are statistically evaluated. For this they are compared with stored reference models. A typical intensity distribution, for example during a full wheel rotation, is stored for each wheel position. This then means that at least parts of the intensity patterns can be compared with at least parts of the reference models. In the case of those comparisons in which the greatest correlation or the greatest correspondence occurs, the received and demodulated identifier is assigned to the wheel position associated with the reference model. This assignment must be carried out at least once during travel (as long as the ignition is switched on). The analysis unit is advantageously connected to the ignition lock 24 in order to identify when the ignition is switched on.

If pressure signals with an identifier are received later, it is known immediately from which wheel position and therefore from which tire module 3 the pressure signal originates, as it is assumed that the tires 2 have not been changed in the meantime.

FIGS. 5A to 5H show the measured intensity patterns (intensity I) on the basis of a wheel angle position a from 0° to 400° (FIGS. 5A, 5C, 5E and 5G) and the frequency H of the amplitudes on the basis of the measured field strength U (FIGS. 5B, 5D, 5F and 5H) for all four wheels (VL=front left, VR=front right, HL=rear left, HR=rear right) in pairs for each wheel position.

As can be seen from FIGS. 5A to 5H the values vary and are scattered not only due to wheel rotation and the associated changes to the transfer path but also due to the tolerances of the individual transmitters 12. All measurements of intensity have in common the fact that the measured intensities of an individual tire module 3 have a typical pattern characteristic of the respective wheel position based on the wheel angle position a. This can then be assigned to a wheel position by comparison with the reference model.

The intensity values form typical models due to wheel rotation (rotation of the transmitter of the wheel module 3 about the wheel axle, due to the non-coaxial positioning of the wheel module on the tire 2). Comparison with the typical reference models can now reveal the wheel (wheel position) from which the signal just received originates, along with the identifier it contains. In this way a wheel position can be assigned on a fixed basis to an identifier and remains valid all the while that the vehicle ignition is switched on or as long as the vehicle is moving. For a tire change is only possible when the vehicle 1 is stationary, so when the vehicle starts up again identifiers have to be reassigned to wheel positions (or a verification has to be carried out to ascertain whether the previous assignment is still valid), before normal operation can start. Otherwise an assignment of identifiers to wheel positions would not be safe, as a tire change could have taken place while the vehicle was stationary.

In normal operation the wheel modules 3 may transmit pressure signals intermittently at intervals, which are for example predetermined by the vehicle speed. If the vehicle speed is low therefore the interval may be longer (less risk of a safety-critical driving situation caused by low air pressure) and at higher speeds the interval may be shorter.

Statistical methods may be used to compare intensity patterns with reference models. The absolute mean of the measured amplitudes may therefore be compared with the mean value of the stored reference models in a simple, but still relatively unsafe comparison. This is successful if the mean values of the different intensity patterns (and therefore also the reference models) are clearly different. Standard deviations and similar statistical variables may also be used for the comparison. It is also possible to determine the frequency (e.g. FIG. 5B) of certain amplitudes and compare this with the reference models. Also the typical frequency distribution for a wheel can provide information about the respective wheel position. Also the difference between the largest and smallest measured intensity values can be used as a comparison criterion in the comparison for example with the mean value.

Ambiguities (identifying one identifier as associated with two possible wheel positions) should be avoided, unless a further criterion is considered, which allows a distinction to be made for example between the left and right wheels or the front and rear wheels. It would then be adequate for the comparisons only to distinguish between front wheels and rear wheels or left and right.

The asymmetrical position of the receiver antenna means that the mean transfer paths between receiver and antenna (distance between wheel axles and antenna) are clearly different for all four operating wheels.

With the measurement results according to FIGS. 5A to 5H the amplitudes/field strengths detected were received by a receiver antenna 5, which is positioned closest to the rear left wheel (HL), as the biggest amplitude is received from there.

1. A method for assigning tire modules to wheel positions of a tire pressure monitoring system for a vehicle, with each tire module having at least one pressure sensor and one transmitter, which transmits a signal to a vehicle-side receiver with a connected analysis unit, in which the signals are analyzed, wherein
assignment is activated by a sensor, when the vehicle or wheel speed is above a reference value,
after this each tire module transmits a number of signals over a predetermined interval together with an identifier specific to a tire,
the signals, which produce a time-based intensity pattern due to wheel rotation, are received by a receiver, the respective intensities are detected and the identifier extracted, and wherein
the intensity patterns received by the receiver are compared with reference models, with a reference model being stored for each wheel position and in the event of at least broad correspondence, the identifiers assigned to the intensity patterns are assigned to the wheel positions.

2. Method according to claim 1, wherein pressure values measured in the tires and/or a specific identifier for each tire are contained in the signals.

3. Method according to claim 1, wherein the vehicle or wheel speed is measured in each wheel by a sensor.

4. Method according to claim 1, wherein the speed data in any case available in the vehicle is used as information about vehicle or wheel speed.

5. Method according to claim 2, wherein a value characterizing wheel rotation and/or a temperature value measured in the tire is contained in the signals.

6. Method according to claim 1, wherein statistical methods are used to analyze the received signals.

7. Device for monitoring the tire pressure of tires on a vehicle, comprising:
a tire module with at least one pressure sensor and one transmitter with a transmitter antenna,
at least one vehicle-side receiver, the receiver antenna of which is positioned asymmetrically in respect of the wheel positions, and
a sensor, which measures wheel acceleration, wheel speed or vehicle speed and which triggers an activation signal for the transmission of signals from the tire-side transmitters to the vehicle-side receiver over a predetermined period, when a reference value has been exceeded.

8. Device according to claim 7, wherein the sensor is an acceleration sensor and one acceleration sensor is located in each tire module.

9. Device according to claim 7, wherein the transmitter is part of a transponder, which sends one or more signals back to the vehicle-side receiver after receiving a prompt signal, transmitted from a vehicle-side transmitter.

10. Device according to claim 7, wherein the sensor is a speed or acceleration sensor in any case in use in the vehicle, with the prompt signal being generated for each tire module, when the vehicle speed is above the reference value.

11. Device according to claim 7, wherein a number of receiver antennas are distributed in the vehicle and positioned asymetrically in respect of the wheel positions and receive the signals from the tire modules, with all the receiver antennas being connected to a central analysis unit.

12. A method for assigning tire modules to wheel positions of a tire pressure monitoring system for a vehicle, with each tire module having at least one pressure sensor and one transmitter, which transmits a signal to a vehicle-side receiver with a connected analysis unit, in which the signals are analyzed, the method comprising the steps of:
activating the assignment by a sensor, when the vehicle or wheel speed is above a reference value,
transmitting a number of signals over a predetermined interval together with an identifier specific to a tire by each tire module,
receiving the signals, which produce a time-based intensity pattern due to wheel rotation, by a receiver,
detecting the respective intensities and extracting the identifier, and
comparing the intensity patterns with reference models, with a reference model being stored for each wheel position and in the event of at least broad correspondence, assigning the identifiers assigned to the intensity patterns to the wheel positions.

13. Method according to claim 12, wherein pressure values measured in the tires and/or a specific identifier for each tire are contained in the signals.

14. Method according to claim 12, wherein the vehicle or wheel speed is measured in each wheel by a sensor.

15. Method according to claim 12, wherein the speed data in any case available in the vehicle is used as information about vehicle or wheel speed.

16. Method according to claim 13, wherein a value characterizing wheel rotation and/or a temperature value measured in the tire is contained in the signals.

17. Method according to claim 12, wherein statistical methods are used to analyze the received signals.
